(19) United States
(12) Patent Application Publication
(10) Pub. No.: US 2005/0040702 A1
(43) Pub. Date: Feb. 24, 2005

(54) Early warning braking system for automobiles

(76) Inventors: Chieh-Cheng Yen, Taipei (TW); Chieh-Fu Yen, Taipei (TW); Wen-Yo Lin, Touliou City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/642,725

(22) Filed: Aug. 19, 2003

(51) Int. Cl. B60T 8/32

(52) U.S. Cl. 303/138

(57) ABSTRACT

An early warning braking system for automobiles is disclosed. An electronic detector is installed in an appropriate location next to the accelerator pedal or the brake pedal to monitor the driver's foot motion, wherein the electronic detector is connected to a pre-braking signal light through the embedded control circuitry. When the car driver's foot is taken off the accelerator pedal, the electronic detector will be able to detect the foot motion, and the control circuit will cause the pre-braking signal light to be turned on to forewarn drivers behind that the car in front is about to slow down or to prepare to stop. This precautionary signal light can be emitted sooner than the regular brake light, giving other drivers more time and more braking distance for stopping their cars.

### BACKGROUND OF THE INVENTION

1. Field of the Invention

The present invention relates to an early warning braking system for automobiles, in particular to a driving safety apparatus that is installed next to the accelerator pedal and the brake pedal to monitor driver's foot motion, whereby any foot motion in preparation of braking can be quickly detected by an electronic sensor, and the embedded control circuit then turns on a pre-braking signal light to forewarn drivers in following cars. Using the electronic detector, the early warning system is able to turn on the pre-braking signal light sooner than the regular brake light, thus providing drivers from behind with more time and more braking distance in response to braking by the car in front.

2. Description of Related Arts

Brake lights of automobiles are mainly used to warn drivers in following cars that the car in front is slowing down or preparing to stop. However, past statistics of road accidents show that the central brake light is not adequate to warn drivers in following cars of the car in front slowing down or braking. In view of road condition changing in a split second, and that the number of cars and the average driving speed are both increasing, the earlier defined safety braking distance between two cars is becoming more difficult to maintain. In order to enhance driving safety, road safety experts have done a lot of research trying to find ways to shorten the brake light response time. They have installed sensors to monitor the foot motion of a driver, and these devices are focused on the accelerator pedal. Experts hoped that by doing so the warning time for braking can be advanced by a few microseconds, to provide drivers in following cars more time to react to an anticipated braking by the front driver.

In the normal conditions, when a following driver sees the brake light from the car in front, it takes about 0.2 sec. for the driver in that following car to make a response by stepping on the brake pedal. For a normal traveling speed of 60 mph, 0.2 sec. is translated to a braking distance of 3.33 meters. If it is possible to eliminate that 0.2 sec. of response time, the driving safety can be much enhanced, and perhaps many traffic accidents can be avoided.

There are many different versions of the early warning braking systems appearing on the market today employing different control circuitry and sensing devices. Most of these devices are designed to turn on the brake light as soon as the driver releases the accelerator pedal, so as to forewarn drivers in following cars of impending deceleration and stopping by the car in front.

However, many of these designs are not practical enough to meet the actual driving requirements. There are occasions when a driver's foot might be taken off the accelerator pedal, but it does not necessarily mean the driver is about to step on the brake pedal. In such a case, the repeated flashing of the brake light will distract and mislead drivers in following cars. Taking the case of a passenger car with manual transmission, when first started up, the car is engaged in the first gear, and then the driver of the car removes his foot from the accelerator pedal to shift into the second gear, and so on and so forth, until the transmission gear is shifted into top gear. The driver's foot is alternately withdrawn from the accelerator pedal every time when the transmission gear is shifted either upward or downward. According to the earlier designs, the braking light will be flashed repeatedly in the car acceleration process, sending wrong messages, time and again, to drivers in following cars as the car in front appears to be about to slow down or stop. Thus, unnecessary annoyance and possible danger for other car drivers may arise.

Another kind of prior art uses a multi-segment brake light, where multiple light patterns are designed to represent different braking conditions. An electronic detector first detects the braking condition, and the control circuitry analyzes the signal and outputs drive signals to the corresponding segments of the braking light for displaying a certain condition to other car drivers. Unfortunately this design creates an effect more decorative than practical since the traffic and road conditions can change so rapidly that drivers do not have time to decipher the meaning behind the multiple segment signal light. When an average driver sees a brake light from the front car, the driver will not second-guess the meaning behind the brake light but will automatically move the right foot from the accelerator pedal onto the brake pedal.

In another prior art, the device employs two signal lights and two control circuitries to command the safety driving light and the braking light. When the driver steps on the accelerator pedal, the safety driving light is turned on, and when his foot is released from the accelerator pedal, another precautionary light is turned on, and when his foot is placed on the brake pedal, the brake light is turned on and the safety driving light and the precautionary light will be turned off. This type of signaling scheme resembles the changing of traffic lights.

The above-mentioned design can produce good display effects, but in reality, since one of the lights is on at any given time during driving, that means drivers in following cars have to stare at the changing of the signal lights to determine the driver's real intention. If there are many cars in a heavy traffic condition, drivers in following cars will be preoccupied by the changing of the lights on the front car, and the driver will not be able to concentrate on the road driving, which is not an ideal situation.

Theoretically speaking, a normal driver's right foot is usually placed on the accelerator pedal, and only when the driver intends to decelerate or prepare to stop will the driver then move the foot from the accelerator pedal to the brake pedal. If every driver behaves in the same way, then the reactions of road drivers can be more predictable. However, in reality, no two drivers behave in exactly the same way, and the drivers' responses cannot be accurately generalized. It is found that novice drivers, for safety reasons or through feeling insecure, often do not place their foot on the accelerator pedal, and instead they put their foot on the brake pedal more often than they do on the accelerator pedal, especially in city driving. If an unusual condition occurs on the road ahead, they step on the brakes right away to save them from hitting an obstacle or the tail end of the front car, but this sudden braking causes problems for car drivers behind, who do not expect the braking by the front car.

In normal situations, when a driver spots an unusual situation on the road in front, the situation might not be serious enough to require significant braking, and the driver may simply release the accelerator pedal and shift the foot toward the brake pedal in preparation of braking, whereby such motion will enable him to react to any situation more quickly. However, for following cars, the drivers are not aware of the changing of the driver's foot from the accelerator pedal to the brake pedal, as the brake light is not activated. Therefore, there is a clear discrepancy in perception between the front driver and the drivers in following cars. When the brake light is eventually activated, there will be a delay time before the drivers from behind can react to the new situation, and if the following cars do not maintain a safe distance from the front car, a traffic accident could occur.

In view of the discrepancy in perception between the front driver and other drivers behind while using the above-mentioned braking system, the inventor has developed an improved model after carrying out intensive research to enhance the driving safety and increase the effectiveness of the braking system.

### SUMMARY OF THE INVENTION

The main object of the present invention is to provide an early warning braking system for automobiles which relies on an electronic detector installed next to the accelerator pedal and the brake pedal to monitor the driver's foot motion, whereby the electronic detector picks up signals from the foot motion, and then the control circuit turns on the pre-braking signal light to forewarn drivers in following cars of impending braking by the front car. The present design is able to activate the pre-braking signal light sooner than regular brake light, giving drivers in the following cars more time to react to the braking by the front car.

According to the present invention, the electronic detector can be placed over and above or next to the accelerator pedal to intercept the path of motion of the driver's foot over the accelerator pedal.

According to the present invention, the electronic detector can also be placed over and above the brake pedal to intercept the path of motion of the driver's foot over the brake pedal.

The pre-braking signal light of the early warning braking system can be designed to give out yellowish or red light or other conspicuous colors.

The control circuit of the early warning system can be properly set up for continuous lighting or flashing modes, depending on the user's needs.

The pre-braking signal light of the present invention can be installed next to the central brake light or next to the brake light at the tail end of the car.

The control circuitry for the early warning system can be slightly modified to support a double filament lighting apparatus, where one filament controls the early warning brake light and the other filament controls the central brake light.

The features and structure of the present invention will be more clearly understood when taken in conjunction with the accompanying drawings.

### BRIEF DESCRIPTION OF THE DRAWINGS

FIG. 1 is a system view of the installation of an electronic detector over and above the accelerator pedal as in the first preferred embodiment of the invention;

FIG. 2 is a view of the signal light installed at the location near to the central braking light;

FIG. 3 is system diagram of the first preferred embodiment of the invention;

FIG. 4 is a transparent view of the structure of the mounting bracket for installing an infrared detector beneath the driver's dash panel;

FIG. 5 is a system view of the installation of an electronic detector over and above the brake pedal as in the second embodiment of the invention;

FIG. 6 is a system view of the installation of an electronic detector on the brake pedal of the car as in the third embodiment of the invention;

FIG. 7 is a system block diagram of the control circuit for the invention; and

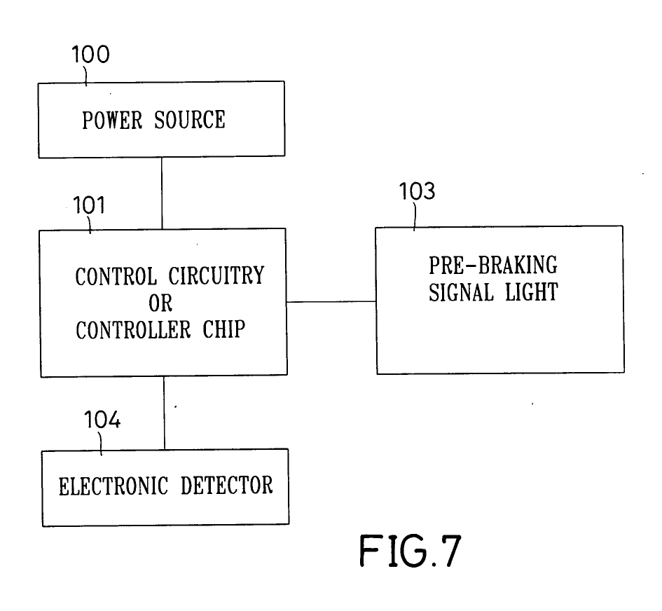

FIG. 8 is a system schematic of the implementation using a photo switch as detector.

### DETAILED DESCRIPTION OF THE PREFERRED EMBODIMENT

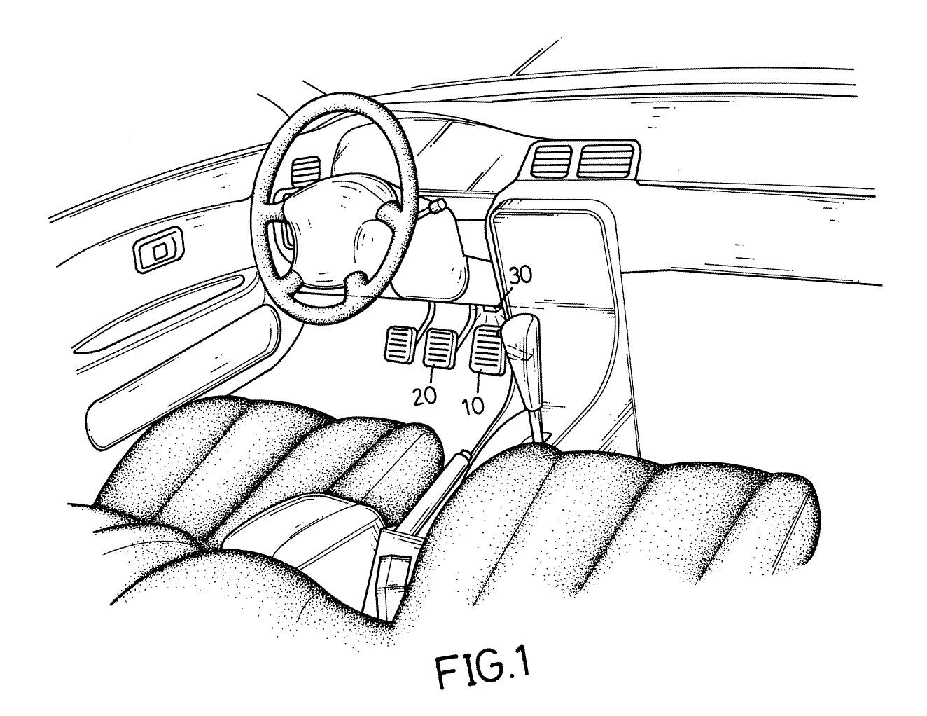

The present invention relates provides an early warning braking apparatus that turns on a precautionary light sooner than the regular brake light when the driver's foot is taken off the accelerator pedal or when the driver's foot presses the brake pedal, to forewarn following cars that the car in front is slowing down or preparing to stop. Referring to FIGS. 1, 2, 5 and 6, the present invention employs an electronic detector (30) installable below the dash panel intercepting the path of motion of the driver's foot between an accelerator pedal (10) and a brake pedal (20), and a control circuit (not shown) is connected to a pre-braking signal light (50) installed next to a central brake light (40) or to the tail-end brake lights.

For the first preferred embodiment, the electronic detector (30) is installed over and above the accelerator pedal (10). When the driver's foot is withdrawn from the accelerator pedal (10), the electronic detector (30) picks up signals and passes them through the control circuit to turn on the pre-braking signal light (50) to forewarn drivers in following cars.

The electronic detector (30) of the present invention can be based on infrared or optical sensing means or any sensing device available, and the set up of the control circuit is typical for an infrared sensing means, commonly used for auto-controlled faucets, urinal bowls, sliding doors, and elevator doors. Since these are conventional circuit designs, the operation principles will not be further discussed in this proposal.

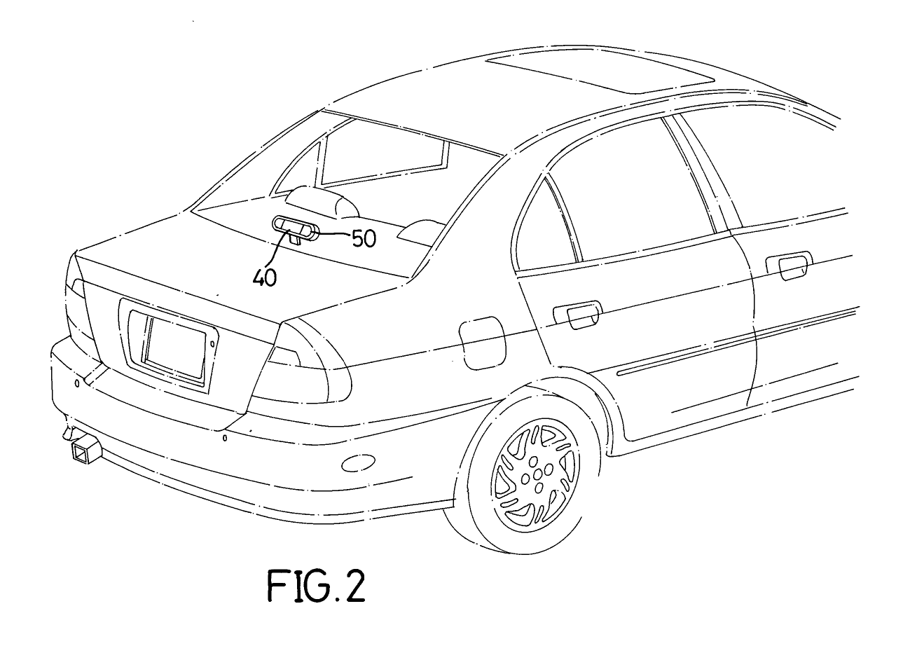

The pre-braking signal light (50), in accordance with the first preferred embodiment, is installable next to the central brake light (40), as shown in FIG. 2, whereby when the driver's foot is placed on the accelerator pedal (10), the electronic detector (30) will detect the foot motion and output signals to the control circuit to cause the pre-braking signal light (50) to be turned on to forewarn drivers behind of impending braking by the car in front. When the driver steps on the brake pedal (20), the brake light (40) will be turned on and the pre-braking light (50) will be switched off.

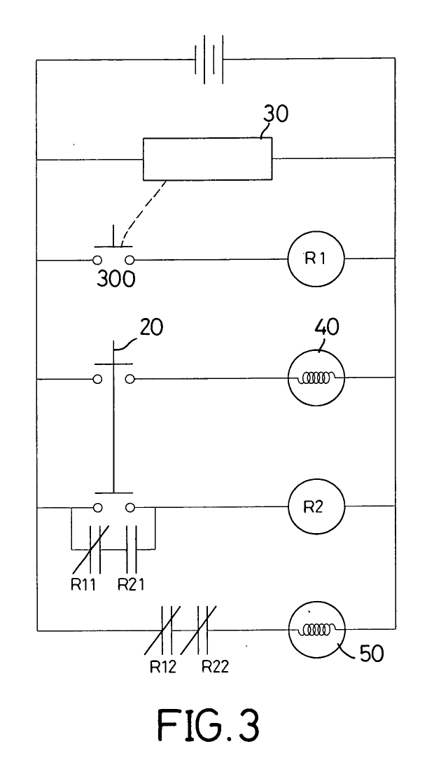

The actual operation of the electronic detector (30) and the control circuitry can be described in conjunction with the system diagram shown in FIG. 3. The electronic detector (30) is used to detect whether the driver's foot is present over the accelerator pedal (10). When the driver's foot is placed on the accelerator pedal (10), the electronic detector (30) picks up signals, and passes them back to the control circuitry, causing the relay switch to be closed, enabling the R1, and switching two normally-closed R11 and R12 to the open position. At this time the pre-braking signal light (50) and the central brake light (40) are both off. When the driver's foot is withdrawn from the accelerator pedal (10), the electronic detector (30) cuts off the signals, and the current passing through the coil R1 is terminated, and R11 and R12 return to the closed position, so the input current is able to pass through series connected R12 and R22 and turns on the pre-braking signal light (50). When the driver's foot steps on the brakes (20), the brake light (40) is turned on. The coil R2 is therefore enabled by the signal through R21, and the normally-closed R22 is switched off causing the pre-braking signal light (50) to be turned off. When the brake pedal (20) is released, the brake light (40) goes off, the normal-closed R12 is in closed position, but since the R2 remains enabled, and the normal-closed R22 remains open, therefore the pre-braking light (50) will not be turned on. When the driver's foot is again moved to the accelerator pedal (10), the electronic sensor (30) is reactivated, and the relay switch (300) is again closed to enable the R1, and to switch R11 and R12 to the open position. Hence R2 is terminated, and the control circuit of the early warning system is reinitiated.

According to the above circuit design, when the driver's foot is withdrawn from the accelerator pedal (10), the pre-braking signal light (50) will be turned on; when the driver's foot steps on the brake pedal (20), the brake light (40) will be turned on, and the pre-braking signal light (50) will be turned off automatically. When the car has stopped and the engine is turned off, at this time, the driver can withdraw his foot from the accelerator pedal (10) or the brake pedal (20) to get out from the car without activating the pre-braking signal light (50). Only when the engine is started and the driver steps on the accelerator pedal (10) will the early warning braking system be initiated again.

The electronic detector (30) of the present invention can be installed over and above the accelerator pedal (10), or below the dash panel, or next to the accelerator pedal (10), wherein the electronic detector (30) is controlled by a control circuit to turn on the pre-braking signal light (50). When the driver's foot is withdrawn from the accelerator pedal (10), the electronic detector (30) detects the foot motion and turns on the pre-braking signal light (50) to forewarn drivers in following cars.

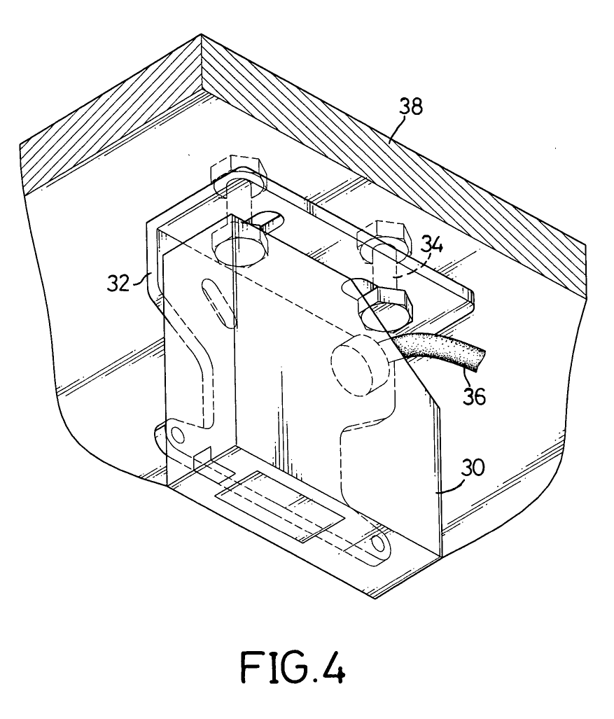

The assembly of the electronic detector (30) in the first embodiment as shown in FIG. 4, is based on an infrared detection means (photo switch) to be installed underneath the dash panel of the car, wherein the screw (34) is inserted into the mounting bracket (32) adjacent to the electronic detector (30) to fix the electronic detector (30) in position on the external wall (38) underneath the dash panel, and the electrical wire (36) is connected to the power source and the pre-braking signal light (50) through the external wall (38).

In the examples described above, the electronic detectors (30) are installed either above or next to the accelerator pedal (10) to detect the withdrawal of driver's foot from the accelerator pedal (10) for activating the pre-braking signal light (50). However, in the following examples, the electronic detectors (30) are installed either above or near the brake pedal (20) to detect the presence of the driver's foot on the brake pedal (20) for activating the pre-braking signal light (50). Regardless of the different approach used by the subsequent embodiments, their common goal is to detect any preparatory foot motion of the car driver to warn drivers behind of impending braking by the car in front.

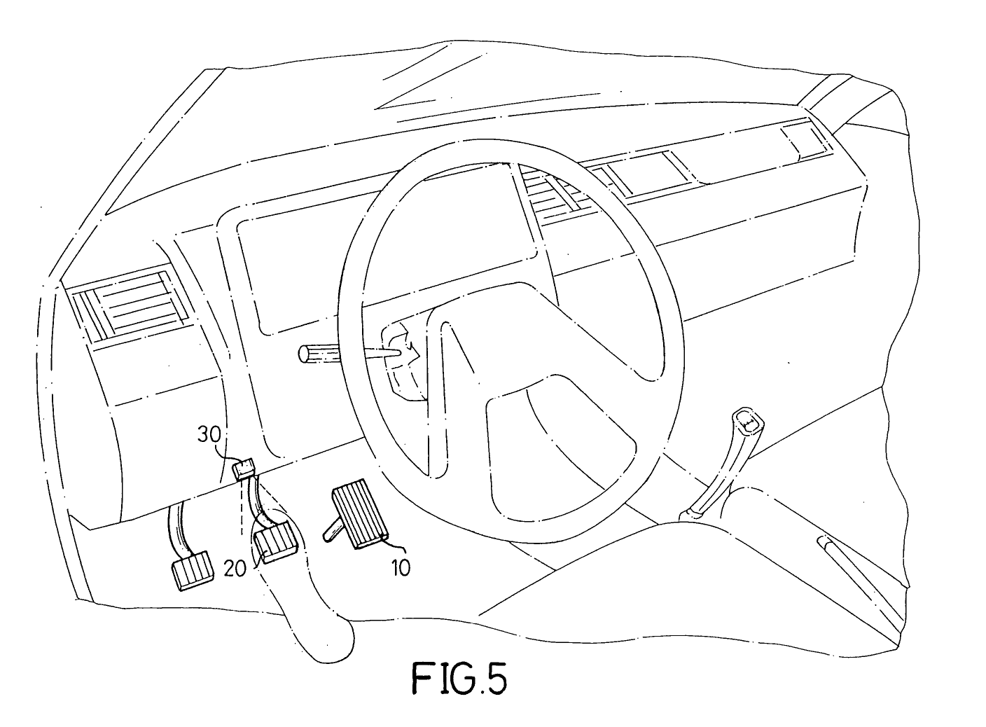

The second embodiment of the invention is shown in FIG. 5, wherein the electronic detector (30) is installed over and above the brake pedal (20), and the electronic detector (30) is connected to an embedded control circuit which is then linked to a pre-braking signal light (50). The control circuit is slightly modified to cope with incoming signals from the electronic detector (30), when the driver's foot is placed over the brake pedal (20). The control circuit then turns on the pre-braking signal light (50).

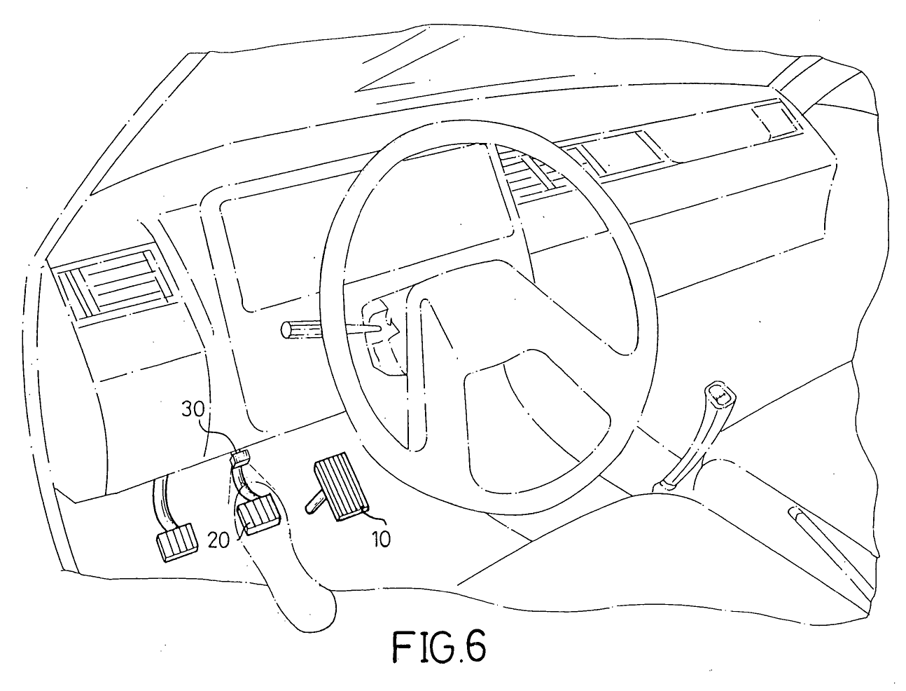

The electronic detector (30) in the third embodiment of the invention can be installed on the brake pedal (20) and underneath the dash panel of the car as shown in FIG. 6. The electronic detector (30) is also connected to the control circuit as mentioned above, and is also linked to the pre-braking signal light (50). Alternatively, the electronic detector (30) can be an infrared detector or any photo sensing means, as shown in FIG. 4, which is fixed by a screw (34) and a mounting bracket (32) on the external wall (38) underneath the dash panel, and the electrical wire (36) is connected through the external wall (38) to the power source and the pre-braking signal light (50).

The pre-braking signal light (50) can be installed next to the central brake light (40), whereby when the driver is about to about to step on the brakes (20), the pre-braking signal light (50) is first turned on and then the central braking light (40) is turned on and at the same time the pre-braking signal light (50) is switched off.

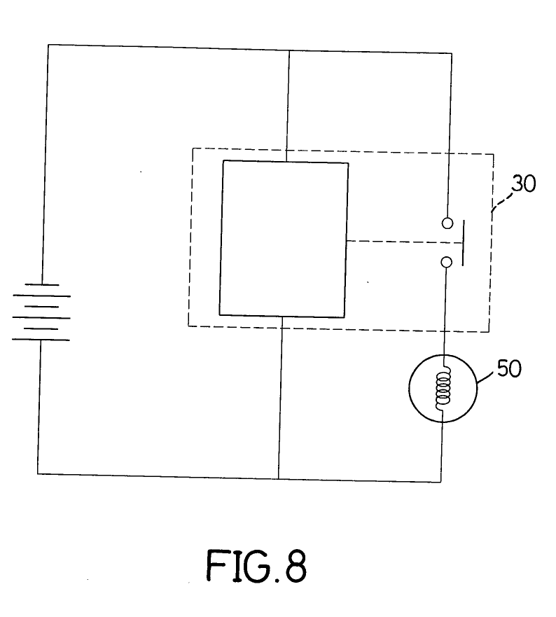

In the foregoing embodiments of the invention, the electronic detector (30) can be an infrared detector or an optical sensor. The assembly of the sensor is demonstrated by FIG. 8, and since all optical sensors have integrated control circuitry, it is only necessary to connect the power line to the power source and the output to the pre-braking signal light (50).

In the second and third embodiments of the invention, the pre-braking signal light (50) can be installed in an appropriate place next to the central braking light (40), as shown in FIG. 2.

In the foregoing embodiments of the invention, the pre-braking signal light (50) can be installed in an appropriate place next to the tail-end brake light.

The pre-braking signal light (50) of the early warning braking system can be designed to give out yellowish or red light or any other conspicuous colors. The control circuit of the early warning system can be properly set up for continuous lighting or flashing modes, depending on the user's needs. Also, the pre-braking signal light (50) of the present invention need not only be installed next to the central brake light (40). The detector can also be installed at an appropriate location next to the brake light at the tail of the car. It is also possible to initiate a minor modification on the control circuitry to combine the pre-braking signal light (50) and the central brake light, using a double filament lamp to represent the early warning brake light and the central brake light.

In the forgoing embodiments of the invention, the pre-braking signal light (50) can be combined with the central braking light, by using a dual filament lamp commonly used by automobiles and motorcycles, wherein the lamp set holds two filaments, one for the regular braking light and the other for the pre-braking signal light.

In the forgoing embodiments of the invention, the pre-braking signal light (50) can be of amber, red, or any other conspicuous colors.

In the forgoing embodiments of the invention, the control circuit (60) can be properly set up for continuous lighting or flashing, depending on the driver's needs.

From the foregoing, the electronic detector (30) of the present invention can be installed at any appropriate location in the path of motion of the driver's foot. In the case where the sensor is installed over and above the accelerator pedal (10), whenever the driver's foot is withdrawn from the accelerator pedal (10), the electronic detector (30) will detect the foot motion and cause the control circuit to enable the pre-braking signal light (50), to forewarn the drivers in following cars of the impending braking. This early warning system can give out a warning signal at least 0.2 sec ahead of the regular braking system, so that the drivers in following cars can have more time to prepare for the braking by the front driver, thus the risk of crashing into the rear end of the front car is largely reduced. For those drivers used to placing their foot on the brake pedal (20), or those other drivers who are used to setting the constant speed driving mode, it is also possible to make use of the early warning braking system to forewarn drivers in following cars to increase the safety distance between two cars.

The foregoing description of the preferred embodiments of the present invention is intended to be illustrative only and, under no circumstances, should the scope of the present invention be so restricted.

1. An early warning braking system for automobiles mainly relies on an electronic detector (30) installable over and above an accelerator pedal (10) or in the vicinity of the accelerator pedal (10) to monitor a driver's foot motion, and the electronic detector (30) is connected to a control circuit that is linked to a pre-braking signal light (50), such that when the driver's foot is withdrawn from the accelerator pedal (10), the electronic detector (30) receives signals of the foot motion, and a control circuit then causes a pre-braking signal light (50) to be turned on for forewarning drivers in following cars of impending braking.

2. The early warning braking system as claimed in claim 1, wherein the electronic detector (30) can be installed underneath a dash panel of the car.

3. The early warning braking system as claimed in claim 1, wherein the electronic detector (30) can be installed over and above the accelerator pedal (10).

4. The early warning braking system as claimed in claim 1, wherein the electronic detector (30) is an infrared sensing means.

5. The early warning braking system as claimed in claim 1, wherein the electronic detector (30) is an optical sensing means.

6. The early warning braking system as claimed in claim 1, wherein the pre-braking signal light (50) can be installed next to a central brake light (40).

7. The early warning braking system as claimed in claim 1, wherein the pre-braking signal light (50) can be installed next to tail-end brake lights (40).

8. The early warning braking system as claimed in claim 1, wherein the pre-braking signal light (50) can be combined with a regular braking light (40), by using a twin filament light apparatus, where one filament represents the pre-braking signal light (50) and the other filament represents a regular braking light for dual function display.

9. The early warning braking system as claimed in claim 1, wherein the pre-braking signal light (50) can be set up by the control circuit for continuous lighting.

10. The early warning braking system as claimed in claim 1, wherein the pre-braking signal light (50) can be set up through the control circuit for flashing mode.

11. An early warning braking system for automobiles mainly relies on an electronic detector (30) installable over and above a brake pedal (20) or in the vicinity of the brake pedal (20) to monitor a driver's foot motion, and the electronic detector (30) is connected to a control circuit that is linked to a pre-braking signal light (50), such that when the driver's foot is stepped on the brake pedal (20), the electronic detector (30) picks up signals of foot motion, and the control circuit causes the pre-braking signal light (50) to be turned on for forewarning drivers in following cars of impending braking of the automobile fitted with the early warning braking system.

12. The early warning braking system as claimed in claim 11, wherein the electronic detector (30) can be installed, underneath a dash panel of the automobile, or over and above the brake pedal (20) of the automobile.

13. The early warning braking system as claimed in claim 11, wherein the electronic detector (30) can be installed on the brake pedal (20).

14. The early warning braking system as claimed in claim 11, wherein the electronic detector (30) is an infrared sensing means.

15. The early warning braking system as claimed in claim 11, wherein the electronic detector (30) is an optical sensing means.

16. The early warning braking system as claimed in claim 11, wherein the pre-braking signal light (50) can be installed next to a central brake light (40).

17. The early warning braking system as claimed in claim 1 1, wherein the pre-braking signal light (50) can be installed next to tail-end brake lights (40).

18. The early warning braking system as claimed in claim 11, wherein the pre-braking signal light (50) can be combined with a regular braking light (40), by using a twin filament light apparatus, where one filament represents the pre-braking signal light (50) and the other filament represents a regular braking light for dual function display.

19. The early warning braking system as claimed in claim 11, wherein the pre-braking signal light (50) can be set up by the control circuit for continuous lighting.

20. The early warning braking system as claimed in claim 11, wherein the pre-braking signal light (50) can be set up through the control circuit for flashing mode.
